(19) United States
(12) Patent Application Publication
(10) Pub. No.: US 2008/0177507 A1
(43) Pub. Date: Jul. 24, 2008

(54) SENSOR DATA PROCESSING USING DSP AND FPGA

(76) Inventors: Zahid F. Mian, Loudonville, NY (US); Peter Hayes, Delmar, NY (US); William VonAchen, Latham, NY (US)

Correspondence Address: HOFFMAN WARNICK LLC, 75 STATE STREET, 14TH FLOOR, ALBANY, NY, 12207, US

(21) Appl. No.: 11/869,981

(22) Filed: Oct. 10, 2007

Related U.S. Application Data
(60) Provisional application No. 60/850,342, filed on Oct. 10, 2006.

(51) Int. Cl. G06F 15/00

(52) U.S. Cl. 702/189

(57) ABSTRACT

A system for managing sensor data, such as video data, includes a processing component for generating processed data based on the sensor data. The processing component can include a digital signal processor (DSP), the DSP including a computer usable medium for storing the processed data, a field programmable gate array (FPGA), and an external memory interface for transferring data between the DSP and the FPGA.

### REFERENCE TO PRIOR APPLICATIONS

The current application claims the benefit of co-pending U.S. Provisional Application No. 60/850,342, titled “Smart sensor module system and device”, which was filed on 10 Oct. 2006, and which is hereby incorporated by reference.

### GOVERNMENT LICENSE RIGHTS

The U.S. Government has a paid-up license in this invention and the right in limited circumstances to require the patent owner to license others on reasonable terms as provided for by the terms of FA8650-06-M-6652 awarded by the United States Air Force.

### TECHNICAL FIELD

The disclosure relates generally to sensor data processing, and more particularly, to a solution for processing sensor data using highly portable and/or low power consumption device(s).

### BACKGROUND ART

Sensor data, such as video (i.e., visible, near-infrared, infrared, and other spectra), acoustic, and other types of sensor inputs/outputs, have become increasingly ubiquitous in various computing applications in recent years. For example, there exists increased interest and concern for computing applications in the areas of safety and security monitoring and surveillance. The proliferation of such data generates a massive amount of information. This in turn creates a need for examining the information to identify events and/or targets of interest.

Because of the large volume of information, much of which is frequently mundane and non-important, human observers do not examine the information effectively. As a result, several approaches use a computer to examine and process the data. These systems are often called “smart sensor” or “smart video” systems, and may incorporate a wide variety of algorithms and heuristics implemented using program code. The algorithms and heuristics range from relatively simple edge detection or contrast enhancement to far more sophisticated visibility enhancement, motion tracking, target identification, and image/data fusion display algorithms. To date, such complex operations are generally carried out in desktop or laptop computers or dedicated fixed-location machines that demand significant constant power input and are too bulky for useful deployment in field conditions.

### SUMMARY OF THE INVENTION

The inventors recognize a need in the art for a solution for processing sensor data, which utilizes a reduced amount of power and/or requires smaller physical device(s). In response, the inventors propose a solution in which the ever increasing volume and numbers of sources of sensor data, such as video, acoustic/sound, and/or the like, can be processed using device(s) that can require a reduced amount of power, a smaller physical size, and/or the like. Such a solution can enable advanced processing of sensor data in numerous low-power and/or light weight applications, such as applications requiring portable/wearable computing systems (military or civilian), remotely controlled and/or deployed devices (e.g., unmanned vehicles), and/or the like.

Aspects of the invention provide a system for managing sensor data, such as video data, includes a processing component for generating processed data based on the sensor data. The processing component can include a digital signal processor (DSP), the DSP including a computer usable medium for storing the processed data, a field programmable gate array (FPGA), and an external memory interface for transferring data between the DSP and the FPGA. In this manner, the system can provide a flexible sensor and data analysis solution, which can implement many different functions.

A first aspect of the invention provides a system for managing sensor data, the system comprising: a processing component for generating processed data based on the sensor data, the processing component including: a digital signal processor (DSP), the DSP including a computer usable medium for storing the processed data; a field programmable gate array (FPGA); and an external memory interface for transferring data between the DSP and the FPGA.

A second aspect of the invention provides a system for managing sensor data, the system comprising: a host computing device; and a sensor data processing device in communication with the host computing device, the sensor data processing device including a processing component for generating processed data based on the sensor data, the processing component including: a digital signal processor (DSP), the DSP including a computer usable medium for storing the processed data; a field programmable gate array (FPGA); and an external memory interface for transferring data between the DSP and the FPGA.

A third aspect of the invention provides a wearable system for managing sensor data, the system comprising: at least one sensor device for generating sensor data; a processing component for generating processed data based on the sensor data, the processing component including: a digital signal processor (DSP), the DSP including a computer usable medium for storing the processed data; a field programmable gate array (FPGA); and an external memory interface for transferring data between the DSP and the FPGA; and an output device for displaying data to a user based on the processed data.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative data processing device according to an embodiment.

FIG. 2 shows an illustrative implementation of the data processing device of FIG. 1 according to an embodiment.

FIG. 3 shows an illustrative wearable image processing system according to an embodiment.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a system for managing sensor data, such as video data, includes a processing component for generating processed data based on the sensor data. The processing component can include a digital signal processor (DSP), the DSP including a computer usable medium for storing the processed data, a field programmable gate array (FPGA), and an external memory interface for transferring data between the DSP and the FPGA. Aspects of the invention can provide a solution for accessing, acquiring, processing, and presenting video and other data from a plurality of sources using a special purpose data processing device, as well as a solution for interfacing this device with other devices, with host computing devices, and/or other processing/display devices. In this manner, the system can provide a flexible sensor and data analysis solution, which can implement many different functions. As used herein, unless otherwise noted, the term “set” means one or more (i.e., at least one) and the phrase “any solution” means any now known or later developed solution.

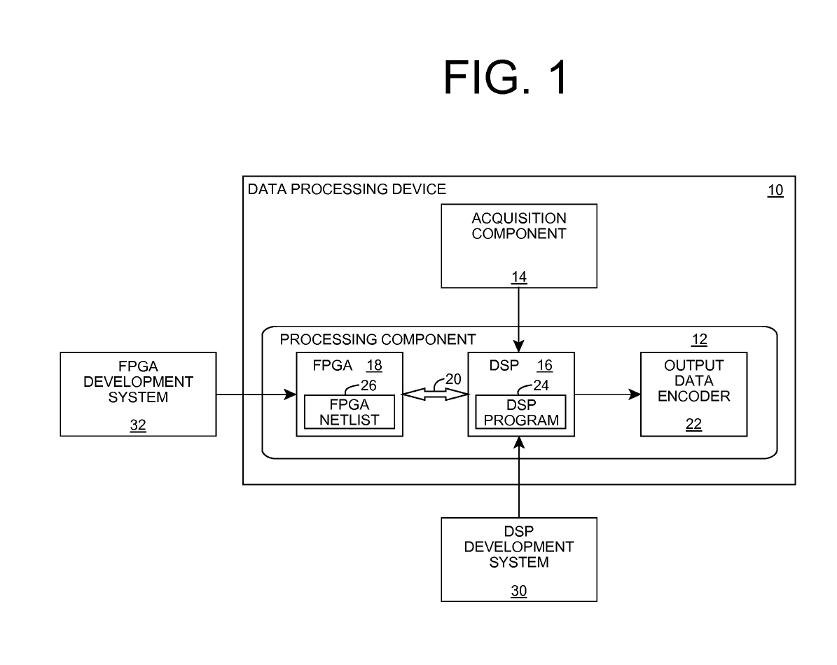

Turning to the drawings, FIG. 1 shows an illustrative data processing device 10 according to an embodiment. To this extent, data processing device 10 includes a processing component 12 and an acquisition component 14. In general, during operation of device 10, sensor data can be received by acquisition component 14, which can convert the sensor data to a processing format (if necessary) and provide the sensor data for use by processing component 12. Processing component 12 can generate processed data based on the sensor data. The processing implemented by processing component 12 can include any type of processing including, for example: analysis of the sensor data, enhancement of one or more features in the sensor data, addition of data to the sensor data, storage of the sensor data, and/or the like.

As illustrated, processing component 12 includes a digital signal processor (DSP) 16 and a field programmable gate array (FPGA) 18. DSP 16 can comprise any type of DSP, such as a DSP in Texas Instruments' DM642 series, which can be optimized for processing digital signal data. Similarly, FPGA 18 can comprise any type of FPGA, such as one in Xilinx's Virtex 4 series. The sensor data processing can be split between DSP 16 and FPGA 18. To this extent, processing component 12 can be configured to enable DSP 16 and FPGA 18 to each perform the appropriate processing on the sensor data in the most effective manner. For example, the use of the computing power of DSP 16 and FPGA 18 can be improved/maximized by assigning to each a portion of the desired processing that is best served by the capabilities and limitations of the DSP 16 or FPGA 18. It is understood that DSP 16 and FPGA 18 are only illustrative. In alternative embodiments, processing component 12 could include one or more alternative data processing components that specialize in implementing relevant processing on the corresponding sensor data.

Regardless, DSP 16 and FPGA 18 can be programmatically configured to implement the corresponding algorithms for processing the sensor data. To this extent, DSP 16 can include a DSP program 24, which can be developed and programmed into DSP 16 using a DSP development system 30. DSP development system 30 can include any signal processing application program interface (API) and toolkit, such as Code Composer Studio offered by Texas Instruments, Inc. Similarly, FPGA 18 can include an FPGA netlist 26, which can be developed and programmed into FPGA 18 using an FPGA development system 32. FPGA development system 32 can include any set of code tools, such as DK Design Suite offered by Celoxica, for translating and transferring standard code, such as C, into an FPGA implementation. Each development system 30, 32 can include a computer program running on a general purpose computing device, which can be temporarily connected to DSP 16 and/or FPGA 18 using any type of communications link that enables the installation of DSP program 24 and/or FPGA netlist 26, respectively.

During operation, DSP 16 and FPGA 18 can communicate and transfer data using any type of data connection 20. In an embodiment, data connection 20 comprises an External Memory Interface (EMIF) 20. EMIF 20 can comprise a high speed data connection that includes separate data, address, and control lines. Additionally, processing component 12 can include an output data encoder 22. DSP 16 can provide processed data to output data encoder 22, which can convert the processed data to an output format and write the converted processed data to a computer usable medium. DSP program 24 can instruct DSP 16 on a time to provide the processed data using any solution. For example, DSP 16 can provide the processed data periodically, after completing a predetermined amount of processing, and/or the like. In an embodiment, the sensor data is video data and output data encoder 22 comprises a standard video encoder that converts the processed video data to an appropriate format for display.

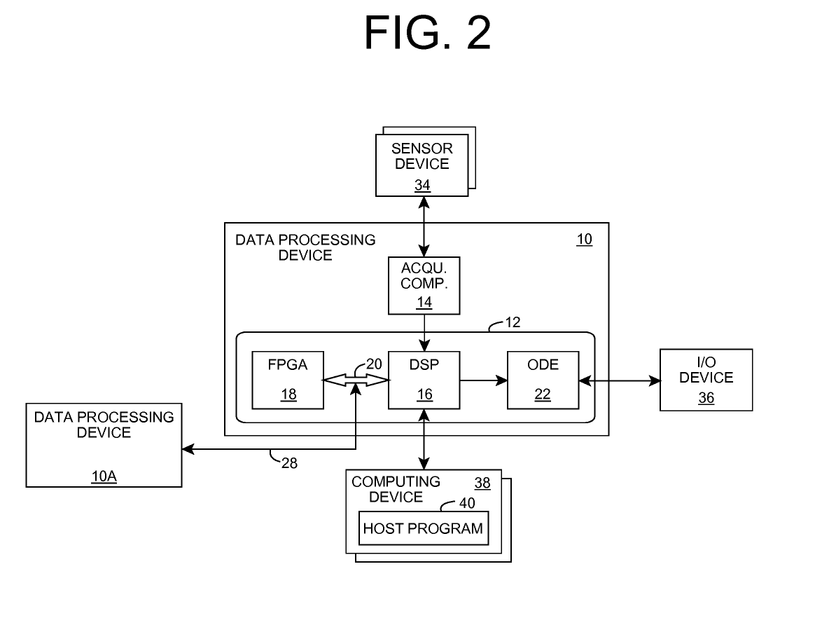

FIG. 2 shows an illustrative implementation of data processing device 10 according to an embodiment. In this embodiment, acquisition component 14 receives sensor data from a set of sensor devices 34. Each sensor device 34 can comprise any type of device for generating any type of sensor data, such as a video source, e.g., camera (visible light, infrared, ultraviolet, and/or the like), acoustic/sound source, and/or the like. Acquisition component 14 can convert the sensor data to a processing format and forward the converted sensor data to processing component 12. For example, acquisition component 14 can include a frame-grabber for video sensor data, an analog to digital converter for audio sensor data, and/or the like.

After processing by DSP 16 and FPGA 18 is complete, DSP 16 can provide the processed data to output data encoder 22, which can convert the processed data to an output format suitable for a corresponding I/O device 36 using any solution. For example, when the sensor data includes video, output data encoder 22 can include a standard video encoder, which can convert the processed data to a format suitable for display on I/O device 36 (e.g., a display device). However, it is understood that video data is only illustrative of various types of sensory output data, which can be generated by output data encoder 22. For example, I/O device 36 could comprise a loudspeaker, a vibration-based signal device, etc., for which output data encoder 22 will perform a suitable conversion using any solution. Output data encoder 22 can write the converted processed data to any computer usable medium. For example, output data encoder 22 can transmit the data to I/O device 36 using any wired or wireless communications solution, write the data to a temporary or permanent storage device, and/or the like.

Data processing device 10 can support various types of data connections. In an embodiment, data processing device 10 can be connected to a second data processing device 10A. In this case, data processing devices 10, 10A can share processed or raw data, enabling the data processing devices 10, 10A to perform enhanced, more complex sensor data processing independent of any host computer. For example, when the sensor data includes video, data processing devices 10, 10A can perform scene reconstruction, stereo recording and presentation, multispectral fusion, image fusion, and/or the like. Regardless, a processing component in data processing device 10A can connect directly to EMIF 20 using a high-speed data bus 28. In this manner, data processing devices 10, 10A can exchange and share data during processing in near real-time. Further, any number of data processing devices 10 can be connected in a similar fashion and can operate in concert or cooperation on a solution, thereby enabling the scaling of a solution, modular implementation of a solution, and/or the like.

Similarly, data processing device 10 can communicate and/or cooperate with a general purpose computing device 38 using any communications solution (e.g., PCI Express bus, USB, and/or the like). In this case, computing device 38 can be running a host program 40, which can provide instructions to data processing device 10 (e.g., processing component 12) on what sensor data to process, which process(es) to perform on the sensor data, and/or the like. Further, data processing device 10 (e.g., DSP 16) can provide processed data for use by host program 40. Additionally, data processing system 10 can communicate with other computing devices (e.g., other general purpose computing devices, other data processing devices, etc.) using any public or private network. For example, data processing device 10 can include an interface for communicating over an IP-based network.

Data processing device 10 can include one or more power-conscious design techniques to limit power consumption and/or power requirements. For example, data processing device 10 can include one or more power-conscious hardware design selections. In particular, one or more components, such as DSP 16, FPGA 18, and/or the like, can be a low-power component, the lowest possible voltage main power rails can be selected to reduce power consumption, the lowest possible clock speeds can be utilized, unused gates can be tied up, the circuit board design can include shorter runs to reduce capacitance, a mixed voltage-mode design can be avoided, interrupt-driven I/O can be utilized instead of polling, and/or the like.

Similarly, the software incorporated into data processing device 10 (e.g., DSP program 24 and/or FPGA netlist 26 of FIG. 1) can include one or more power-conscious design techniques. For example, the device drivers can include an embedded power-save feature and/or main system software control can be provided through predetermined power usage states. Further, numerous techniques to speed up code execution and minimize inefficient processing (e.g., by minimizing transfers between buffers when a process can be set to operate only on the final buffer) can be implemented. Still further, one or more system-level approaches and design features can be utilized to reduce power consumption. For example, data processing device 10 can use buffering to store information when I/O rates are mismatched and/or erratic, burst mode data transfer can used to write data to a storage device rather than using a constant mode, a processor can be throttled down when less performance is required, suspend and/or auto-shutoff modes can be implemented, a self-learning kernel can learn how a user tends to use data processing device 10 and minimize and/or power off subsystems that the user does not often access, etc.

In any event, the hardware selection and design for data processing device 10 permits an extremely compact, lightweight, multifunctional data capture and processing appliance that uses industry standard interfaces for peripheral attachments (USB, VGA, Ethernet, etc.). In an embodiment, data processing device 10 permits advanced image/sensor data processing untethered to a full-scale computing device (e.g., computing device 38). This permits multiple simultaneous laboratory and field applications for data processing device 10. The capabilities of a set of data processing devices 10, which can be many BIPS (Billions of instructions per second) or more, permit video (and/or other) sensor data processing ranging from rudimentary enhancement to complex multispectral, multi-location fusion to be performed independently of any host computing device.

Referring to FIGS. 1 and 2, in an embodiment, data processing device 10 can be dynamically reconfigured using DSP development system 30 and/or FPGA development system 32. For example, the corresponding DSP program 24 and/or FPGA netlist 26 can enable core-level reconfiguration to meet an immediate application demand using an asymmetric hardware architecture, runtime swapping of algorithms, and/or the like. Similarly, data processing device 10 can enable remote (e.g., via an IP-based network) reprogramming of DSP program 24 and/or FPGA netlist 26 by DSP development system 30 and/or FPGA development system 32, respectively. Additionally, data processing devices 10, 10A can include support for integration in one of various types of network topologies (e.g., star, mesh, and/or the like), thereby enabling selection of a network topology that best suits a particular application.

Data processing device(s) 10 can be implemented in a large number of various types of applications as implied by the non-limiting description herein. In an illustrative embodiment, a data processing device 10 can capture data stream(s) from a set of sensor devices 34, process the data stream(s) according to a predetermined set of algorithms (possibly with the assistance of one or more additional data processing devices 10A), and forward the processed data for presentation to a user on one or more I/O devices 36. To this extent, a sensor device 34 can comprise a video source, which provides video data for processing by data processing device 10, which in turn provides processed video data for presentation on a display device 36. The processed video data can include a set of enhancements of various types.

A particular illustrative application is deployed military personnel. In this case, it would be beneficial if such troops were able to use advanced imaging technology to detect, identify, track, and/or the like, both friendly and enemy forces in all weather and lighting conditions. Current approaches do not readily acquire data from multiple disparate video sources, process the data, and display it in a manner that is intuitively and instantly useful to a soldier without requiring a prohibitive amount of equipment or consuming an excessive amount of power.

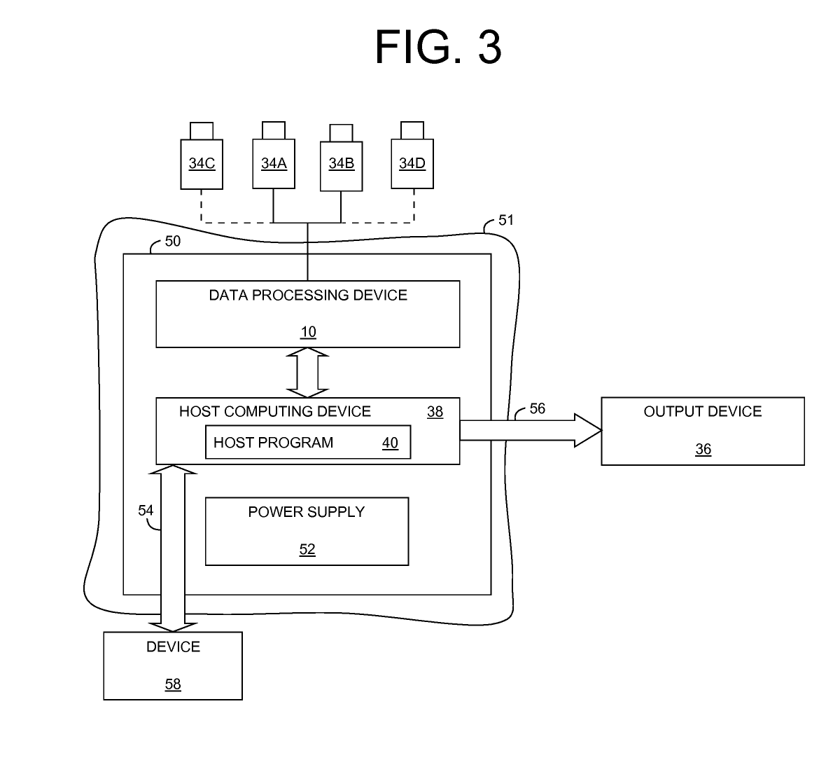

FIG. 3 shows an illustrative wearable image processing system 50 according to an embodiment. System 50 can be incorporated into any type of garment 51 for holding system 50 against a body of a user. For example, system 50 could be included in a vest, a backpack, a belt, and/or the like. System 50 can be used as an image processing development platform and a wearable computing device for, for example, a soldier in the field. In this case, system 50 can provide the soldier with enhanced situational awareness through advanced image and data processing and presentation. System 50 is shown including a data processing device 10, a host computing device 38 executing a host program 40, and a power supply 52. Host computing device 38 can be specifically selected for a small size and low power demands, and can direct the sequence and type of processing performed by data processing device 10 via host program 40. Power supply 52 supplies power to data processing device 10, host computing device 38, and/or sensor device(s) 34A-D, and can comprise a rechargeable battery, fuel cell, or other portable means of supplying sufficient electrical power at the appropriate voltages for a desired amount of time. With an appropriate selection of host computing device 38 and appropriate data storage, system 50 could replace the use of a laptop computer in a more compact, yet still user-friendly and high capacity, form factor.

System 50 can accept sensor data from multiple sensor devices 34A-D, at least one of which is an image/video source, which is processed by data processing device 10. It is understood that system 50 can include any number of data processing devices 10, which can be selected based on the quantity of sensor data to be processed and processing requirements for the particular application. In any event, as illustrated, data processing device 10 forwards the processed sensor data to host computing device 38, which can write the processed sensor data to an output 56 for presentation on an output device 36. To this extent, output 56 can comprise a standard video output, such as VGA, S-Video, or other display technology. Output device 36 can comprise any type of display device including, for example, imaging goggles. While host computing device 38 is shown writing the processed sensor data to output 56, it is understood that data processing device 10 could write the processed sensor data to output 56 for display on output device 36.

Additionally, system 50 (data processing device 10 and/or host computing device 38) can include other I/O ports 54, which can enable the exchange of data with other device(s) 58, such as processing devices, sensors, user input and/or output devices (e.g., keyboard/keypad, mouse, speakers, etc.), and/or the like. For example, host computing device 38 could receive data from a GPS unit or the like, which can also be provided for display on output device 36 as, for example, a current location on a visual map. Additionally, host computing device 38 could receive data from a user input device, which enables a user (e.g., the individual wearing system 50) to configure the operation of system 50 (e.g., data processing device 10 and/or host program 40).

It is understood that system 50 is only illustrative of various portable and/or wearable embodiments. To this extent, in an embodiment, system 50 can be implemented without host computing device 38. In this case, one or more data processing devices 10 can provide all the required processing for the sensor data received from sensor device(s) 34A-D, as well as include all the required interfaces for connecting to other systems and/or devices, such as output device 36 and/or device 58. Further, a host computing device 38, which can comprise a general purpose computing device (e.g., a laptop, desktop, or the like) can be temporarily connected to system 50 (via a direct interface or a public/private network) to adjust the operation of data processing device(s) 10, transfer historical data, and/or the like. This embodiment can be utilized for applications in which the user will require use of system 50 for relatively short durations.

For example, system 50 can provide a highly portable, multispectral, and/or multichannel processing capability for, for example, a first responder, such as a firefighter, law enforcement officer, and/or the like. In particular, especially for a firefighter, sensor devices 34A-D can include video devices that acquire video data based on visible light and near-infrared, two or more acoustic sensors, and an infrared imaging device. A set of data processing devices 10 can include a suite of sensor processing, enhancement, and fusion algorithms tailored for the environment of a burning building. In this manner, data processing devices 10 can: detect, highlight, alert, and/or the like, the user (e.g., a firefighter) to a location of a potential flashover spot; perform acoustic directional tracking and location; perform visual and infrared overlay fusion to assist the user in navigating through a smoke-filled area, and/or the like.

Similarly, system 50 can function to present a virtual environment, e.g., for an entertainment device. In this case, a set of data processing devices 10 can accept sensor data that is computer-generated, e.g., environmental simulation data. To this extent, system 50 can perform operations of the computer-generated data to present it in a preferred format to a user. For example, a remote wireless system can generate and transmit representative data of the overall features of a local environment (real or virtual) rather than image data of the local environment. System 50 can receive the representative data, generate additional detail, and format the data for display at a local output device 36. In this manner, the processing and bandwidth demands on the remote system and the wireless network, respectively, can be reduced. Illustrative applications for this embodiment include advanced virtual reality games, combat/flight simulators, and/or the like, in which one or more users may be present in the same virtual environment and in which computational and transmission demands would otherwise limit the ability to present a realistic and interesting environment to a user on a local output device 36.

System 50 (without a host computing device 38) also can be utilized in applications that require remote, distributed units that are placed in a fixed location. For example, multiple systems 50 can be distributed around an area to be secured, e.g., a military camp/base perimeter. In this case, each system 50 is placed at a predetermined location around the perimeter and attached to a set of sensor devices 34A-D (e.g., video, audio, and/or the like). The set of data processing devices 10 for each system 50 can include a security-related suite of algorithms for: detecting, tracking, identifying, and/or the like a target; evaluating a condition/situation, and/or the like. The systems 50 can communicate with each other and/or a central controlling system, thereby alerting a central location of any detected anomalies, combining data across the perimeter for a big picture view, and/or the like.

Since each data processing device 10 can permit remote or direct programming adjustments on the fly, data processing device 10 can be utilized in an improved vision processing development platform. In particular, data processing device 10 can be communicatively connected to a laboratory computer that is used to modify algorithms and their application while the data processing device 10 is functioning. In this manner, a researcher can develop, test, and evaluate new algorithms and vision processing and presentation approaches in a more efficient and realistic fashion than that provided by current development platforms. For example, a data processing device 10 can receive visible and infrared-based video data, and perform various types of visible/infrared fusion on the video data, which is provided for display on a display device. A researcher can adjust the parameters of each type of fusion in real-time, permitting a direct and immediate evaluation in a test environment of the adjustments.

In another embodiment, the invention provides a method of managing a system for managing sensor data. In this case, a service provider can: obtain (e.g., create, acquire, access, etc.) a data processing device 10 (FIG. 1) and/or image processing system 50 (FIG. 3); obtain (create, acquire, use, modify, etc.) one or more programs/systems for performing a process described herein; deploy the programs/systems to the device 10 and/or system 50; and/or maintain/manage operation of device(s) 10 and/or system(s) 50. To this extent, the deployment can comprise one or more of: (1) installing program code on a computing device from a computer-readable medium; (2) adding one or more components to the device 10 and/or system 50; and (3) incorporating and/or modifying the device 10 and/or system 50 to enable it to perform a process described herein.

It is understood that aspects of the invention can be implemented as part of a business method that performs a process described herein on a subscription, advertising, and/or fee basis. That is, a service provider could offer to manage sensor data as described herein. In this case, the service provider can manage (e.g., create, maintain, support, etc.) a data processing device 10 and/or image processing system 50 that performs a process described herein for one or more customers. In return, the service provider can receive payment from the customer(s) under a subscription and/or fee agreement, receive payment from the sale of advertising to one or more third parties, and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system for managing sensor data, the system comprising:
a processing component for generating processed data based on the sensor data, the processing component including:
a digital signal processor (DSP), the DSP including a computer usable medium for storing the processed data;
a field programmable gate array (FPGA); and
an external memory interface for transferring data between the DSP and the FPGA.

2. The system of claim 1, further comprising a sensor device for acquiring the sensor data.

3. The system of claim 2, wherein the sensor device comprises a video source.

4. The system of claim 1, further comprising a sensor data acquisition device for receiving the sensor data, converting the sensor data to a processing format, and forwarding the converted sensor data to the processing component.

5. The system of claim 1, the processing component further including an output data encoder for converting the processed data to an output format and writing the converted processed data to a computer usable medium.

6. The system of claim 5, further comprising a display device for displaying the converted processed data.

7. The system of claim 1, further comprising:
a second processing component for generating processed data based on the sensor data; and
a high-speed data bus for enabling direct memory sharing between the processing components using the external memory interface.

8. The system of claim 7, wherein the processing components perform at least one of: image fusion, scene reconstruction, stereo presentation, or multispectral fusion.

9. The system of claim 1, further comprising a host program executing on a general purpose computer system in communication with the processing component, wherein the host program provides instructions on at least one of: the sensor data to process or a process to perform on the sensor data to the processing component and wherein the processing component provides the processed data for use by the host program.

10. A system for managing sensor data, the system comprising:
a host computing device; and
a sensor data processing device in communication with the host computing device, the sensor data processing device including a processing component for generating processed data based on the sensor data, the processing component including:
a digital signal processor (DSP), the DSP including a computer usable medium for storing the processed data;
a field programmable gate array (FPGA); and
an external memory interface for transferring data between the DSP and the FPGA.

11. The system of claim 10, further comprising a sensor device for acquiring the sensor data.

12. The system of claim 10, the sensor data processing device further including a sensor data acquisition device for receiving the sensor data, converting the sensor data to a processing format, and forwarding the converted sensor data to the processing component.

13. The system of claim 10, the processing component further including an output data encoder for converting the processed data to an output format and writing the converted processed data to a computer usable medium.

14. The system of claim 13, further comprising a display device for displaying the converted processed data.

15. The system of claim 10, further comprising:
a second sensor data processing device for generating processed data based on the sensor data; and
a high-speed data bus for enabling direct memory sharing between the sensor data processing devices using the external memory interface.

16. The system of claim 10, further comprising a host program executing on the host computing device, wherein the host program provides instructions on at least one of: the sensor data to process or a process to perform on the sensor data to the sensor data processing device.

17. A wearable system for managing sensor data, the system comprising:
at least one sensor device for generating sensor data;
a processing component for generating processed data based on the sensor data, the processing component including:
a digital signal processor (DSP), the DSP including a computer usable medium for storing the processed data;
a field programmable gate array (FPGA); and
an external memory interface for transferring data between the DSP and the FPGA; and
an output device for displaying data to a user based on the processed data.

18. The system of claim 17, further comprising a sensor data acquisition device for receiving the sensor data, converting the sensor data to a processing format, and forwarding the converted sensor data to the processing component.

19. The system of claim 17, further comprising a host program executing on a general purpose computer system in communication with the processing component, wherein the host program provides instructions on at least one of: the sensor data to process or a process to perform on the sensor data to the processing component and wherein the processing component provides the processed data for use by the host program.

20. The system of claim 19, further comprising a user input device for enabling the user to configure operation of the processing component.
